(19) United States
(12) Patent Application Publication
(10) Pub. No.: US 2004/0079854 A1
(43) Pub. Date: Apr. 29, 2004

(54) Column unit

(76) Inventors: Dong Kwan Ma, Gyeonggi-do (KR); Gi Jong Kim, Seoul (KR)

Correspondence Address: HOLLAND & KNIGHT LLP, 633 WEST FIFTH STREET, TWENTY-FIRST FLOOR, LOS ANGELES, CA, 90071-2040, US

(21) Appl. No.: 10/686,378

(22) Filed: Oct. 15, 2003

(30) Foreign Application Priority Data
Oct. 16, 2002 (KR) 63081/2002

(51) Int. Cl. F16M 13/00

(52) U.S. Cl. 248/631

(57) ABSTRACT

A column unit is disclosed, in which a guide sleeve is adhered to the external surface of a spindle by an adhesive for metal, thereby allowing the spindle to stably perform a long stroke. The column unit provided with a spindle that moves up and down in a base tube to adjust the height of chair or table includes a cylindrical shaped guide sleeve fixed onto the external surface of the spindle from an upper portion of the spindle to a height lower than its lower portion, moving up and down along with the spindle, and an adhesive layer applied between the guide sleeve and the spindle to fixably adhere the guide sleeve to the spindle. Therefore, the stroke length of the spindle can stably be increased and the adhesive is simply used to adhere the guide sleeve to the spindle, thereby saving the cost for mass production.

### BACKGROUND OF THE INVENTION

1. Field of the Invention

The present invention relates to a column unit, and more particularly to a column unit in which a guide sleeve is adhered to the external surface of a spindle by an adhesive for metal, thereby allowing the spindle to stably perform a long stroke.

2. Discussion of the Related Art

A well-known column unit called “gas spring” is applied to a leg portion of furniture such as chair and table at an adjustable height.

The column unit includes a spindle movably up and down fitted into a base tube and a cylinder formed inside the spindle. The cylinder is provided with a piston to divide the inside into two chambers. An upper end of a piston rod is fixed to the piston and its lower end is fixed to a base panel of a base tube. The cylinder is filled with pressure gases. The two chambers divided by the piston are communicated with each other by a bypass channel. A gas switch pin controls the bypass channel. That is, if the gas switch pin is pushed, the bypass channel connects the chambers to each other and the spindle is pushed upwardly by force of the pressure gasses filled in the cylinder.

It is natural that the adjustable height of the conventional column unit depends on the up and down stroke height of the spindle. Therefore, it is necessary to increase the height of the spindle and the base tube in order to increase the adjustable height of the column unit.

However, if the height of the spindle is only increased in a state that other parts are maintained as they are, a problem arises in that up and down stroke of the spindle becomes unstable.

To solve this problem, a guide sleeve moving along with the spindle may be provided on the external surface of the spindle. Namely, to move up and down the guide sleeve along with the spindle, it is required that the guide sleeve has lower and upper ends positioned at a height lower than lower and upper ends of the spindle and at the same time it is fixed to the external surface of the spindle. Accordingly, if the guide sleeve is provided in the column unit having the same spindle, it is possible to increase the stroke length of the spindle and more stable stroke of the spindle can be obtained.

The guide sleeve is fixed to the column unit either by strike at least once or using a screw after being inserted into the external surface of the spindle. In this case, disadvantages occur in view of the cost and the process time for mass production.

### BRIEF SUMMARY OF THE INVENTION

The present invention is directed to a column unit that substantially obviates one or more of the problems due to limitations and disadvantages of the related art.

An object of the present invention is to provide a column unit provided with a guide sleeve and a bushing that can obtain a long and stable stroke of a spindle, wherein the guide sleeve is fixed onto the external surface of the spindle by an adhesive for metal, thereby reducing process steps in mass production, improving working efficiency, and saving the production cost.

Additional features and advantages of the invention will be set forth in the description which follows, and in part will be apparent from the description, or may be learned by practice of the invention. The objectives and other advantages of the invention will be realized and attained by the scheme particularly pointed out in the written description and claims hereof as well as the appended drawings.

To achieve these and other advantages and in accordance with the purpose of the present invention, as embodied and broadly described, in a column unit provided with a spindle that moves up and down in a base tube to adjust the height of chair or table, the column unit according to the present invention includes a cylindrical shaped guide sleeve fixed onto the external surface of the spindle from an upper portion of the spindle to a height lower than its lower portion, moving up and down along with the spindle, and an adhesive layer applied between the guide sleeve and the spindle to fixably adhere the guide sleeve to the spindle.

The spindle to which the guide sleeve is fixed is fitted into the base tube to move up and down in the fixed base tube, and between the internal surface of the tube guide and the external surface of the guide sleeve a bushing having a lubricant layer therein is formed and fixed to the internal surface of the tube guide to allow its lower and upper portions to be positioned higher than lower and upper portions of the tube guide.

The adhesive layer has a thickness of 0.005˜0.6 mm.

It is to be understood that both the foregoing general description and the following detailed description are exemplary and explanatory and are intended to provide further explanation of the invention as claimed.

### BRIEF DESCRIPTION OF THE ATTACHED DRAWINGS

The invention will be described in detail with reference to the following drawings in which like reference numerals refer to like elements wherein:

FIG. 1 is a longitudinal sectional view of a column unit according to the first embodiment of the present invention.

FIG. 2 is an enlarged view of a portion “A” of FIG. 1.

FIG. 3 is a perspective view of a column unit according to the second embodiment of the present invention.

FIG. 4 is a sectional view taken along line IV-IV of FIG. 3.

FIG. 5 is an enlarged view of a portion “B” of FIG. 4.

FIG. 6 is a perspective view of a bushing which is an element of the column unit according to the second embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

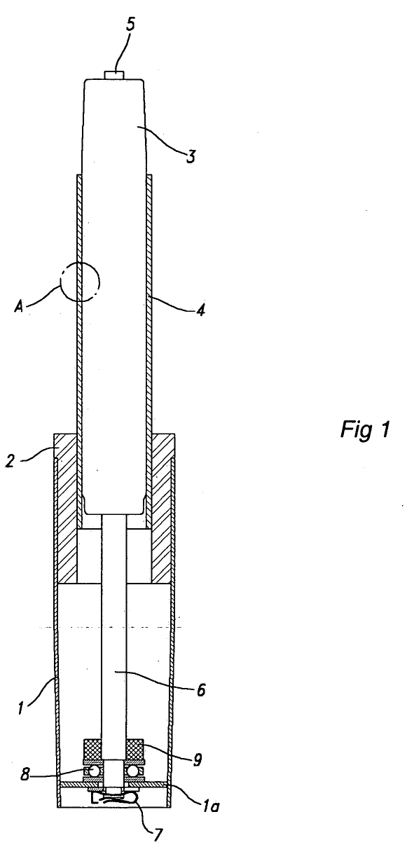

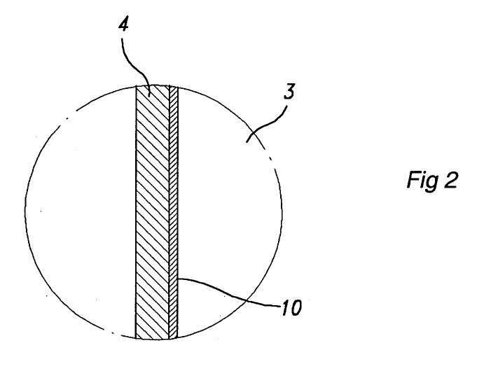

A column unit according to the first embodiment of the present invention will be described with reference to FIGS. 1 and 2.

As shown, the column unit includes a spindle 3 movably up and down provided inside a base tube 1 and a guide sleeve 4 fixed onto the external surface of the spindle 3. The guide sleeve 4 moves up and down along with the spindle 3, generating friction with a tube guide 2 fitted into the base tube 1. The spindle 3 has the same structure as that of a general column unit. Therefore, its detailed description will be omitted.

A piston (not shown) is fitted into the spindle 3. A piston rod 6 is connected to the piston. The lower end of the piston rod 6 is fixed to a spindle support 1a of the base tube 1 by a clip 7.

Therefore, once pressure is applied to the spindle 3 from the upside in a state that a gas switch pin 5 is pushed, the spindle 3 and the guide sleeve 4 move downwardly. Once the pressure is removed, they move upwardly by means of pressure of gas filled in the spindle 3. This operation is the same as that of a general column unit.

In the column unit according to the first embodiment of the present invention, since the guide sleeve 4 is fixed to the external surface of the spindle 3, it makes the same operation as the spindle 3. Furthermore, since the lower end of the guide sleeve 4 is positioned lower than the lower end of the spindle 3, many portions of the guide sleeve 4 make a contact with the tube guide 2 even when the spindle moves upwardly to the maximum range. In this case, the guide sleeve 3 acts to take hold of the spindle 3 so that the spindle 3 cannot roll from side to side.

FIG. 2 illustrates an enlarged structure of the guide sleeve 4 fixed to the external surface of the spindle 3.

As shown in FIG. 2, an adhesive layer 10 is formed between the guide sleeve 4 and the spindle 3. Preferably, the adhesive layer 10 has a thickness of 0.005˜0.6 mm and an adhesive (powered base adhesive) for metal is used as the adhesive layer 10.

In the first embodiment of the present invention, 1300 series adhesive by Threebond in Japan has been used. In the process for mass production, the guide sleeve 4 is fitted into the spindle 3 at a proper position. In this state, the adhesive is applied between the spindle 3 and the guide sleeve 4 from the upper side and then hardened to form the adhesive layer 10. The adhesive may be applied partially between the spindle 3 and the guide sleeve 4. Once the spindle 3 is adhered to the sleeve 4 by properly applying the adhesive thereto, no problems occur in view of strength and durability.

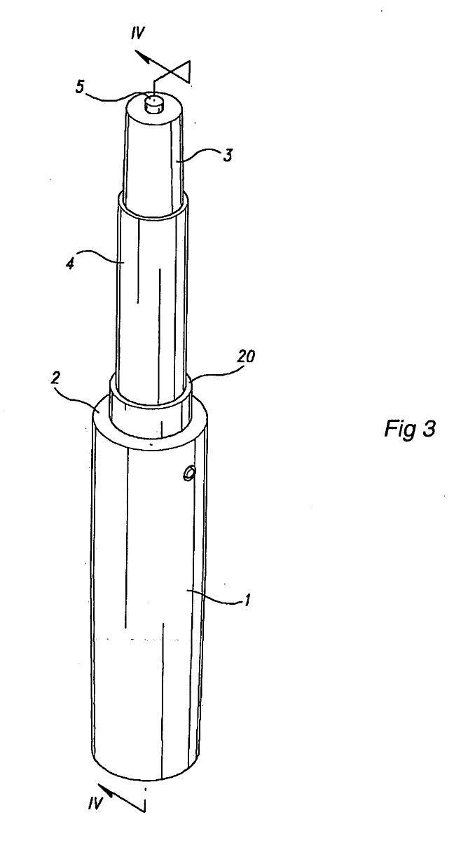

Meanwhile, FIG. 3 to FIG. 6 illustrate the column unit according to the second embodiment of the present invention. FIG. 3 is a perspective view of the column unit according to the second embodiment of the present invention.

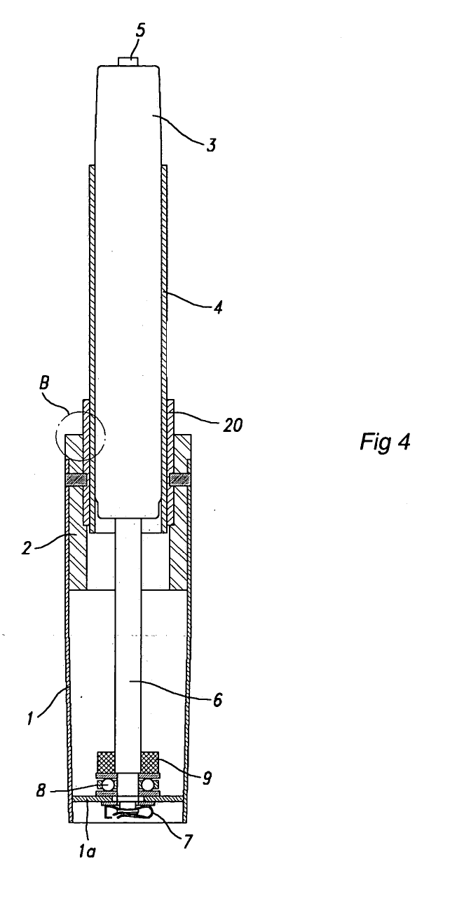

Unlike the first embodiment, a bushing 20 is provided in the second embodiment of the present invention. That is, as shown in FIG. 3, the bushing 20 is additionally provided between the tube guide 2 and the guide sleeve 4. The bushing 20, as shown in FIG. 4, is fixed in such a manner that its top portion is positioned at a certain height from the top of the tube guide 2. In this case, the supporting power of the spindle 3 can be improved. Therefore, the bushing 20 has an advantage in that more stable spindle 3 having longer stroke can be designed.

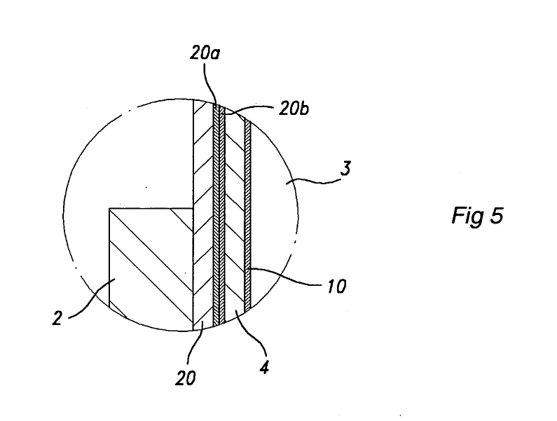

FIGS. 4 and 5 illustrate detailed structures of the guide sleeve 4 and the bushing 20. As shown in FIGS. 4 and 5, the adhesive layer 10 is formed between the spindle 3 and the guide sleeve 4 in the same manner as the first embodiment. The bushing 20 is fitted between the guide sleeve 4 and the tube guide 2. A lubricant layer 20a of nylon and a grease layer 20b are formed between the bushing 20 and the guide sleeve 4. Preferably, the nylon layer has a thickness of 2˜1000 μm.

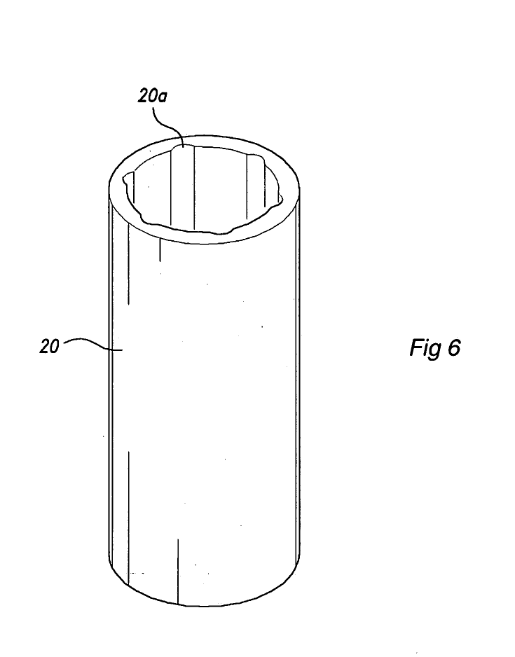

FIG. 6 is a perspective view of the bushing 20 having a cylindrical shape, in which a plurality of vertical grooves 20c are formed to be filled with a great amount of grease.

In the aforementioned column unit of the present invention, the guide sleeve 4 and the bushing 20 allows the spindle 3 to have a longer stroke length and stable movement. Also, the lubricant layer 20a and the grease layer 20b allow the spindle 3 to smoothly move up and down.

In the second embodiment of the present invention, 1300 series-adhesive for metal by Threebond in Japan has been used too. Reference numerals 8 and 9 denote a bearing and an impact bumper, respectively. The bearing 8 supports the end of the piston rod to rotate the spindle.

As described above, the column unit according to the present invention has the following advantages.

Since the guide sleeve and the bushing are provided, the stroke length of the spindle can stably be increased. In addition, since the guide sleeve is fixably adhered to the external surface of the spindle by the adhesive for metal, the cost for mass production can be saved.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

Although the present invention has been described by way of exemplary embodiments, it should be understood that many changes and substitutions may be made by those skilled in the art without departing from the spirit and the scope of the present invention, which is defined by the appended claims.

What is claimed is:

1. A column unit to adjust the height of a product comprising:
a base tube;
a spindle moving up and down in the base tube;
a cylindrical shaped guide sleeve fixed onto the external surface of the spindle from an upper portion of the spindle to a height lower than the lower end of the spindle, moving up and down along with the spindle; and
an adhesive layer applied between the guide sleeve and the spindle to fixably adhere the guide sleeve to the spindle.

2. A column unit according to claim 1, further comprising a bushing placed between the internal surface of a tube guide placed inside of the base tube and the external surface of the guide sleeve to enhance supporting strength of the spindle.

3. A column unit according to claim 2, wherein the bushing has a lubricant layer therein.

4. The column unit according to claim 2, wherein the bushing is fixed to the internal surface of the tube guide to allow its upper portion to be positioned higher than upper portion of the tube guide.

5. The column unit according to claim 2, wherein the bushing is cylindrical shape.

6. The column unit according to claim 2, wherein the bushing has a plurality of vertical grooves therein.

7. The column unit according to claim 3, wherein the lubricant layer is a nylon layer.

8. The column unit according to claim 7, wherein the nylon layer has a thickness of 2˜1000 μm.

9. The column unit according to claim 1, wherein the adhesive layer has a thickness of 0.005˜0.6 mm.

10. A column unit to adjust the height of a product comprising:
a base tube;
a spindle moving up and down in the base tube;
a guide sleeve fixed onto the external surface of the spindle;
an adhesive layer formed between the guide sleeve and the spindle to fixably adhere the guide sleeve to the spindle;
a tube guide inserted into the inside of the base tube to support the guide sleeve; and
a piston rod and piston fixed to the base tube.

11. A column unit according to claim 10, wherein the adhesive layer is formed at the gap in-between the guide sleeve and the spindle by applying the adhesive from the top of said gap.

12. A column unit according to claim 10, wherein the adhesive layer is formed at the gap in-between the guide sleeve and the spindle by partially applying the adhesive into the gap.

13. A column unit according to claim 10, wherein the lower end of the guide sleeve is placed below the lower end of the spindle.

14. A column unit according to claim 10, wherein the upper end of the guide sleeve is placed in the upper portion of the spindle.

15. A column unit according to claim 10, further comprising a bushing placed between the internal surface of the tube guide and the external surface of the guide sleeve to enhance the supporting strength of the spindle.

16. A column unit to adjust the height of a product comprising:
a base tube;
a spindle moving upward and downward directions along the base tube;
a guide sleeve fixed to the outer surface of the spindle, wherein the guide sleeve is fixed to the spindle in the manner of adhesion;
a piston rod relatively fixed to a base tube; and
a piston inserted into the spindle to form gas chamber in the spindle, wherein the piston is combined with the piston.
